(19) United States
(12) Patent Application Publication
(10) Pub. No.: US 2007/0222588 A1
(43) Pub. Date: Sep. 27, 2007

(54) Personal property security device

(75) Inventor: Daniel G. Wolfe, Highland, UT (US)

Correspondence Address: J. HARRISON COLTER, 333 SOUTH 520 WEST, SUITE 310, LINDON, UT, 84042, US

(73) Assignee: Red Wolf Technologies, Inc.

(21) Appl. No.: 11/800,029

(22) Filed: May 2, 2007

Related U.S. Application Data
(63) Continuation-in-part of application No. 11/090,668, filed on Mar. 22, 2005.
Application No. 11/090,668 is a continuation-in-part of application No. 10/738,437, filed on Dec. 17, 2003, now abandoned.
Application No. 10/738,437 is a continuation-in-part of application No. 10/636,348, filed on Aug. 7, 2003.
Application No. 10/636,348 is a continuation-in-part of application No. 09/943,913, filed on Aug. 31, 2001, now Pat. No. 6,700,762.
(60) Provisional application No. 60/230,608, filed on Sep. 6, 2000.

(51) Int. Cl. G08B 1/08

(52) U.S. Cl. 340/539.13

(57) ABSTRACT

A mobile monitoring device includes a sensor, a controller and a transceiver is in electronic communication with the controller. The transceiver is capable of secure, bidirectional communication with a computing device, or with other devices such as telephones and the Internet. The sensor is in electronic communication with the controller and is capable of detecting a change in a condition of the property being monitored or the area proximate thereto. The monitoring device executes programming commands received from the computing device or other devices or networks. The monitoring device is track-able by various methods. The monitoring device is configured for bi-directional communication with RF sensors to provide a mesh network topology for monitoring numerous items and a relatively large area with small, inexpensive devices. Communications may be digital or analog using recognized or proprietary communications protocols, and may be secured using various encryption algorithms and protocols. Digitization permits proper delivery and authentication and remote programming of each individual device, as well as ensuring the accuracy and reliability of such communications. Communications may be sent along various routes, permitting a user, a security monitoring company and any computer applications to receive and to respond to notifications, including automatic responses to notifications.

### CROSS-REFERENCE TO RELATED APPLICATIONS

This application claims priority based on co-pending U.S. application Ser. No. 11/090,668, which is a continuation-in-part of U.S. patent application Ser. No. 10/738,437, filed Dec. 17, 2003, which is a continuation-in-part of U.S. patent application Ser. No. 10/636,348 filed Aug. 7, 2003, which is a continuation-in-part of U.S. patent application Ser. No. 09/943,913 filed Aug. 31, 2001, now U.S. Pat. No. 6,864,789, which claimed priority based on U.S. Provisional Application No. 60/230,608 filed Sep. 6, 2000. These prior applications are incorporated herein by reference.

### BACKGROUND OF THE INVENTION

The present invention relates to devices, systems and methods for providing personal property security. A mobile monitoring security device of the present invention includes a communications interface that is capable of providing information regarding the status, condition, location and surroundings of the monitoring device and the personal property being monitored by the device to a user. The communications interface also gives the user the ability remotely to make programming changes to the security device. More specifically, the present invention relates to a device for providing automated notice of disturbances to personal property and automated tracking of movement of the personal property and to a method and system for remotely managing the device along with a network of devices and sensors and to systems for providing automated information regarding the status, condition, surroundings and location of fixed or mobile property.

Many personal, enterprise or government property items are vulnerable to theft, vandalism, or damage from external forces. Monitored security systems can be ineffective and expensive. Monitored security systems are frequently large, immobile and slow to respond. The inability to monitor the area around the item may also result in numerous false calls or an inability to identify damaging events while still occurring, thereby increasing the likely damage. Thieves and vandals of small items are seldom caught, and the personal property is seldom recovered.

Currently available security systems typically require an owner or operator to be physically present to activate, deactivate or program the security systems. When a security system is activated or needs to be reconfigured or changed, the owner or operator may be required to go to the location and manually, activate, reconfigure or reset the system. The requirement of being physically present has proven to be cumbersome, particularly when the security system is at a job location, such as a construction site, located far from the owner or operator of the security system, or where a number of sites exist with personal property that needs to be monitored. Remotely activated and programmed devices could conveniently be programmed at any time from a remote location, eliminating the need for an owner or operator to travel to the property or properties and reset, program or reconfigure the security systems. Remote monitoring of conditions of the security systems and devices and conditions proximate to the security systems and the personal property being monitored by the security systems would also be useful.

Current security systems often notify a security company designated to receive information relating to the security systems. Notifying a designated security company may be ineffective because the security systems frequently do not have sufficient information about the status, condition, surroundings and location of the property being monitored by the security system. In addition, security companies are frequently ill equipped to monitor various types of property. Frequently, security companies notify local authorities whenever a security system is activated. Law enforcement personnel are often too busy to investigate such notifications, and if the notification is a false alarm, responding merely wastes valuable time and resources and frustrates the police.

What is needed is a device for securing personal property that is portable, simple, inconspicuous, effective, and economical, that can effectively monitor the status, condition, surroundings and location of various types of personal property and that can be managed, either separately or in conjunction with several of other security devices, remotely, inexpensively and efficiently. Such a device should be inconspicuous and highly effective in providing notification of status, condition, surroundings and location to a wide array of personal property, including vehicles, power tools, bicycles, trailers, boats, stereos, and televisions or other subjects (such as children or pets) and should be sufficiently economical to be purchased by a wide cross-section of consumers. Such a device may be manageable remotely through various access and management mechanisms including various computing devices and communications and data networks. Upon a change of status, condition, attitude, surroundings and location of personal property, such a device should be effective to provide notification of the change and provide tracking information regarding any movement of the personal property to enable identification and apprehension of possible perpetrator(s) and enable quick recovery of the property.

### SUMMARY OF THE INVENTION

The present invention provides an inexpensive security monitoring device and system for securing or monitoring personal property. The device and system of the present invention may be remotely activated and programmed to provide automated notice of changes in status, condition, attitude, surroundings and location of personal property and automated tracking of movement of attached or monitored personal property. A communications interface in the monitoring device provides communications between a controller, a transceiver, a location identifier, and various detection and interrogation sensors and various tagging or monitoring devices to provide information regarding the status, condition, attitude, surroundings and location of the device, the other tagging or monitoring devices in communication with the security device, and the personal property being monitored by the device. In one embodiment, an incorporated voice menu system permits a user to interact with the security device using telephone or other audible means using a user transceiver. The communications interface also gives the user the ability to remotely make programming changes to the security device.

The user may subscribe to a security monitoring company or application service provider to assist in monitoring. The security system of the present invention allows a user to augment the system by incorporating bilateral communications between the system, devices in the system, data networks, user transceivers, and computing devices, including computing devices managed by a monitoring company, or with applications provided by service providers. Bilateral communications permit exchange of information and instructions between each device in the system, thereby permitting the user and the monitoring company or service provider significant flexibility in remote and on-site operation of the system.

The present invention allows a user to procure a security device that couples to a cellular or other wireless transceiver and is operational over generally available wireless communications and data networks. The security device may be attached to personal property or even to a person. Upon a change of status, condition, attitude, surroundings or location, the security module may be programmed to initiate and establish a communication link or maintain an established link with the user over a wireless (e.g., cellular, personal computer system, satellite, etc.) network directly to the user by means of the communication link or indirectly to the user through a computer processing application and interface, including one or more computing devices included in or separate from the communications network.

The security device may be activated, reconfigured or programmed, or one or more diagnostic routines may be activated, through remote or on-site direct interaction with the security device or through a communications or data network, or through the facilities of a computing application designed to support the system. The remote or on-site interaction may include discovery, activation or reconfiguration of other security devices, tagging devices, or motion sensors, shock sensors, audible/sound sensors, moisture sensors, humidity sensors, fire sensors, temperature sensors, detachment sensors, smoke sensors, carbon monoxide sensors, chemical sensors, video sensors, and magnetic sensors, and may also include running one or more diagnostic routines to determine the operational capability of the device, and devices or sensor for which communications have been configured or which have been discovered by the device. A low-battery sensor may also be added to measure the power supply of the security device.

A user, or a security monitoring company, or both, may receive communications from the security device directly by the communications link, or may receive an alert or other notification, either spontaneously or as a result of a query by the user, the security monitoring company or a computing application through a communications or data network. Depending on the information transmitted in the communications, the user, the security monitoring company or computing application may evaluate the legitimacy of the alarm by various means, including listening to audible sounds originating in the proximity of the security device, or monitoring the sensors of the security device through various communications interfaces, including an Internet web or voice interface. The user, security monitoring company or computing application may also employ optional interrogation sensors (e.g., imagery, infrared, motion, temperature, etc.) located about the security device to further determine the status, condition, surroundings or location of the personal property being monitored.

Once the nature of the alarm has been verified, the location of the security device, sensors or other devices with which it is capable of communication, may gather and transmit location data for the device, sensors or other devices to the user, the security monitoring company, or the computing application, and may also activate one or more location identifiers within the security device, making the device, sensors or other devices subject to tracking by the user, security monitoring company or computing application. Tracking may be activated by the user initiating a decodable keypad sequence recognized by the security device, or by a computer program or data or communications protocol decodable by the device, or activation may be time delayed or even immediate upon detection of an alarm condition. Tracking may assume one of several approaches, such as a transmitting beacon located within the security device that may be detected by a tracking receiver used by the user or security monitoring company, or a receiving location-based system (e.g., a global positioning satellite or GPS unit, or a wireless or cell infrastructure-based system) that allows the coordinates of the security device to be determined and forwarded to the user or security monitoring company over the communication link.

Additionally, the security device may be configured to execute one or more programming commands issued by a user, computing device or computing application. Possible programming commands include a command to discover, activate or deactivate one or more of the tagging devices, sensors, or other security devices; a command to activate or deactivate the tracking transmitter; a command to activate or deactivate the low-battery sensor; a command to activate or deactivate the alarm system; a command to change the automatic clock; a command to activate or deactivate lights; a command to activate or deactivate speakers; a command to activate or deactivate a microphone; a command to activate or deactivate a camera; a command to notify the local authorities of a change in status, condition, surroundings or location of the personal property being monitored; a command to turn the security device on or off; or a command to perform various other desired functions.

Communications through the communications interface may be digital or analog according to well recognized or proprietary communications protocols. Communications through the communications may further be secured using various encryption algorithms and protocols. Such digitization permits proper delivery and authentication of each communication as well as ensuring the accuracy and reliability of such communications. Digitized communications may also be sent along various routes, permitting both the user, the security monitoring company and one or more computing applications to receive and to respond to notifications, as well as allowing one or more computing devices to automatically respond to various expected notifications. These protocols also allow remote programming of each individual device by the user, the security monitoring company, one or more computing applications, or a computer system.

The apparatus of the present invention has been developed in response to the present state of the art, and in particular in response to the problems and needs in the art that have not yet been fully solved by currently available personal property security devices and systems. Thus, the present invention alleviates many of the problems of prior security devices. These and other features and advantages of the present invention will become more fully apparent from the following description, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates one environment and configuration, in accordance with one embodiment of the present invention;

FIG. 1B illustrates an environment and configuration of one or more security monitoring devices that form an effective system of protecting personal property, in accordance with one embodiment of the present invention;

FIG. 1C illustrates a monitoring device according to one embodiment of the invention with detail regarding certain electrical components of the device;

FIG. 1D illustrates a device according to one embodiment of the invention along with auxiliary devices and a U.S. dime to provide perspective as to size;

FIG. 2 illustrates a block diagram of the security system, in accordance with one embodiment of the present invention;

FIG. 3 illustrates a detailed block diagram of the security device in accordance with another embodiment of the present invention;

FIG. 4A is a flow diagram of the security methods implemented by the device, in accordance with an embodiment of the present invention;

FIG. 4B is a continuation of the flow diagram of the security methods implemented by the device, in accordance with an embodiment of the present invention;

FIG. 4C is a continuation of the flow diagram of the security methods implemented by the device, in accordance with an embodiment of the present invention;

FIG. 4D is a continuation of the flow diagram of the security methods implemented by the device, in accordance with an embodiment of the present invention;

FIG. 4E is a continuation of the flow diagram of the security methods implemented by the device, in accordance with an embodiment of the present invention;

FIG. 4F is a continuation of the flow diagram of the security methods implemented by the device, in accordance with an embodiment of the present invention;

FIG. 4G is a continuation of the flow diagram of the security methods implemented by the device, in accordance with an embodiment of the present invention;

FIG. 4H is a continuation of the flow diagram of the security methods implemented by the device, in accordance with an embodiment of the present invention;

FIG. 5 is a flow diagram of a monitoring method, in accordance with an embodiment of the present invention; and

FIG. 6 is a mechanical embodiment of an integrated transceiver and a security module, in accordance with an embodiment of the present invention.

### DETAILED DESCRIPTION

Those of ordinary skill in the art will appreciate that various modifications to the details of the Figures may be made without departing from the essential characteristics of the invention. The components and systems of the present invention, as generally described and illustrated in the Figures herein, could be arranged and designed in a wide variety of different configurations. The illustrations are merely representative of certain embodiments of the invention. Those embodiments of the invention may best be understood by reference to the drawings.

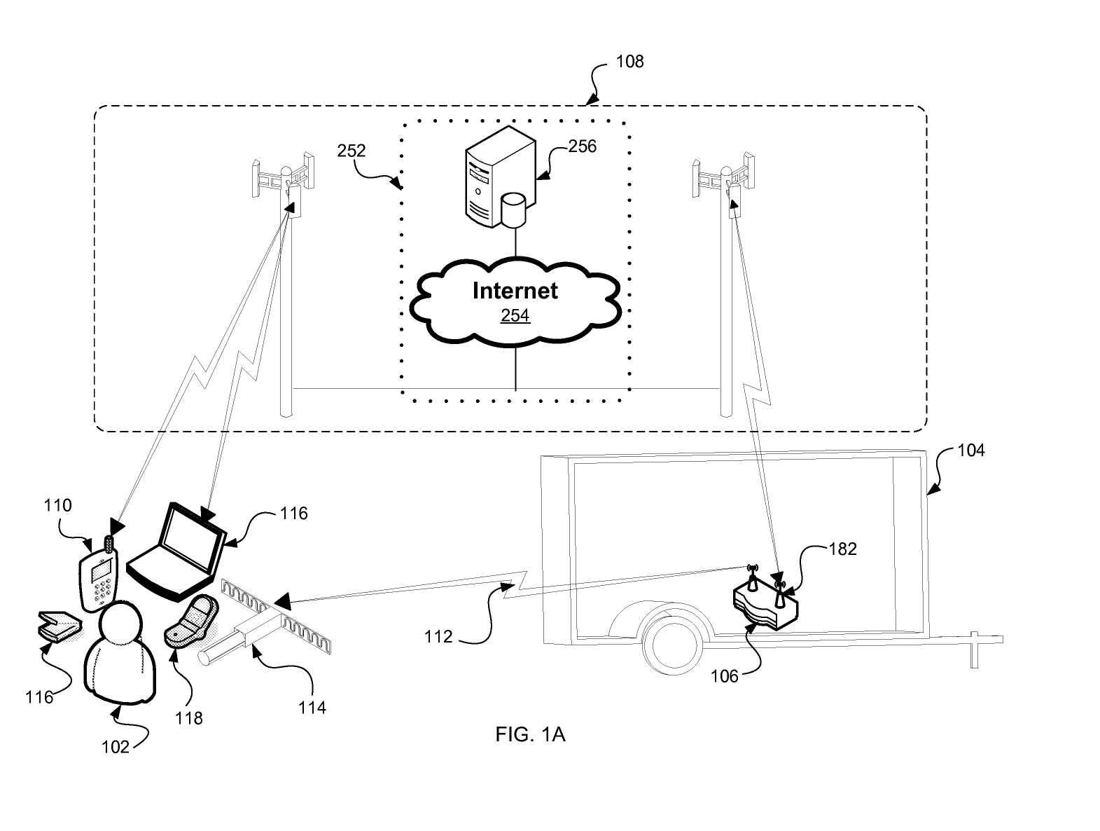

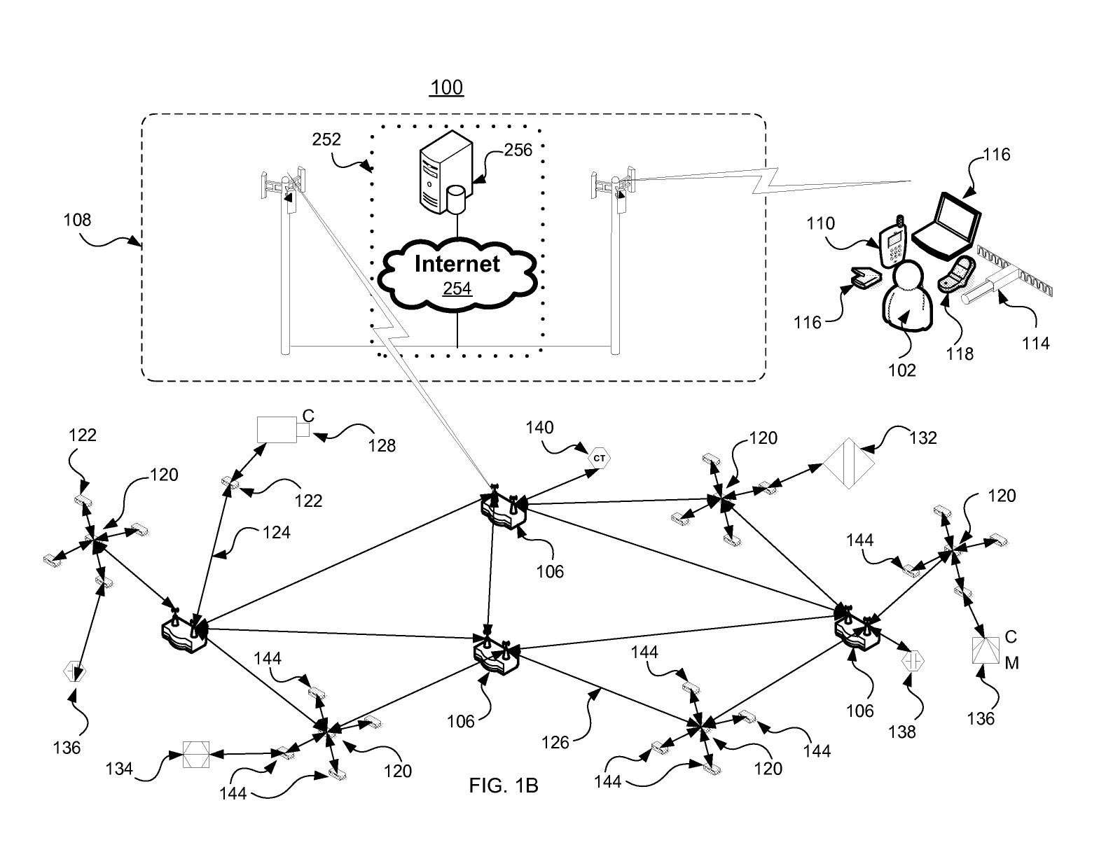

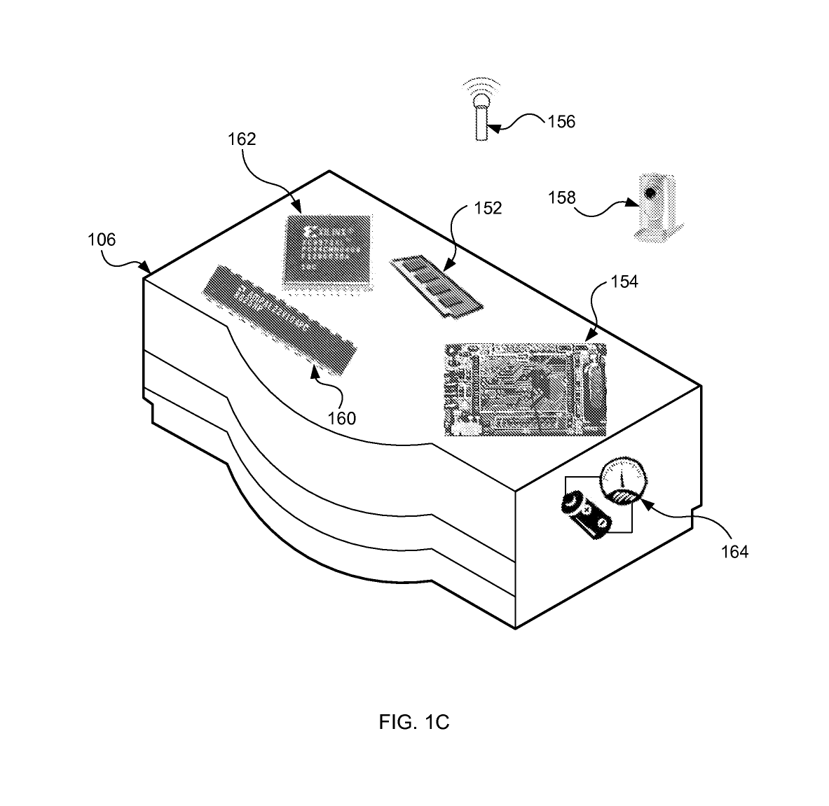

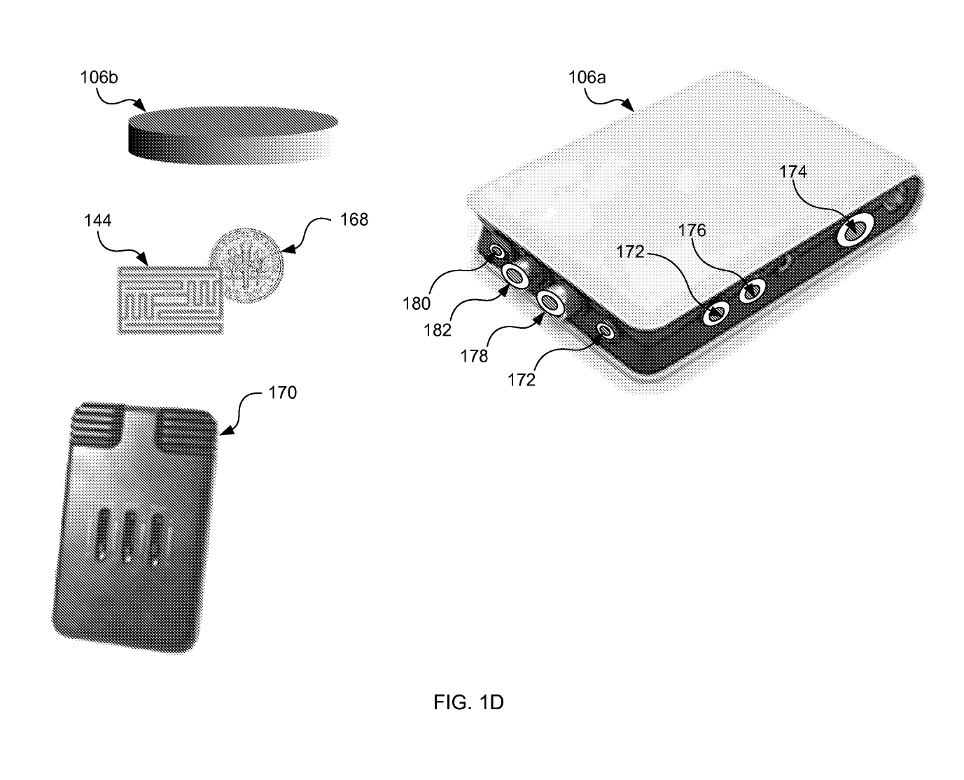

FIG. 1A illustrates a system for securing personal property and detecting and tracking an unauthorized or unanticipated intrusion or removal of personal property, or the condition, attitude or location of the personal property, or a condition of the area proximate to personal property, including monitoring of other property or facilities in the vicinity. As illustrated, a user 102 desires to secure a personal property asset 104, which may be of various forms including mobile assets, stationary assets, or other types of property whose status and/or location may be of interest to the user 102. The present invention facilitates the monitoring of the asset 104 through the inclusion of a security device 106 within the confines or surroundings of the personal property asset 104. The user 102 activates a security device 106 to monitor or be aware of surroundings about the security device 106 by directly interacting with the security device 106, or by interacting with the security device 106 through a user transceiver 110 that initiates a communication link through a communication network 108 or through a computing device 116. The computing device may be of various forms, including a personal computer or a personal digital assistant 116 or smart phone 118, connected to the communication network 108.

FIG. 1B illustrates an embodiment of the current invention to provide a system of securing personal property and detecting and tracking unauthorized or unanticipated intrusion or removal of personal property. As illustrated, more than one security device 106 may be interconnected using a star network topology where a security device 106 is in a bidirectional communication 126 with an additional security device 106. Alternatively, more than one security device 106 may be interconnected using a mesh network topology where the security device 106 is interconnected with other security devices through a variety of bidirectional communication channels.

As illustrated in FIG. 1B, the security device 106 may be interconnected either directly with additional devices 120 that are capable of further interconnecting with other additional devices 122, or a security device may be directly interconnected with a device 122. Additional devices 120 and additional devices 122 may have varying capabilities, including the capability of interfacing with and controlling or receiving data from a camera 128, a motion detector 130, a proximity sensor 132, a temperature sensor 134, a moisture sensor 136, an infrared sensor 138, a current sensor 140, a microphone 156, or one of any other sensors. As indicated by the arrows, each of these sensors is capable of bidirectional communication with one or more of the security devices 106 or with one or more of the additional devices 120 or 122, or both.

In one embodiment of the invention, the security device 106 communicates with additional devices 120 and 122 using an analog communications protocol. In another embodiment of the invention, the security device 106 communicates with devices 120 and 122 using a digital communications protocol. The communications protocol may use sophisticated routing to determine the best communications path to a device. The communications protocol may include channel routing, congestion routing, fault-tolerant routing, and other routing techniques known to those skilled in the art.

Furthermore, the additional devices 120 and 122 may be RF transmitters using protocols useful for various frequencies. Each of the additional devices 120 and 122, as well as the monitoring devices 106 may include memory to store data therein. Use of RF transmitters permits the use of RFID devices, such as RFID devices 144 shown in bidirectional communication with certain additional devices 120 in FIG. 1B.

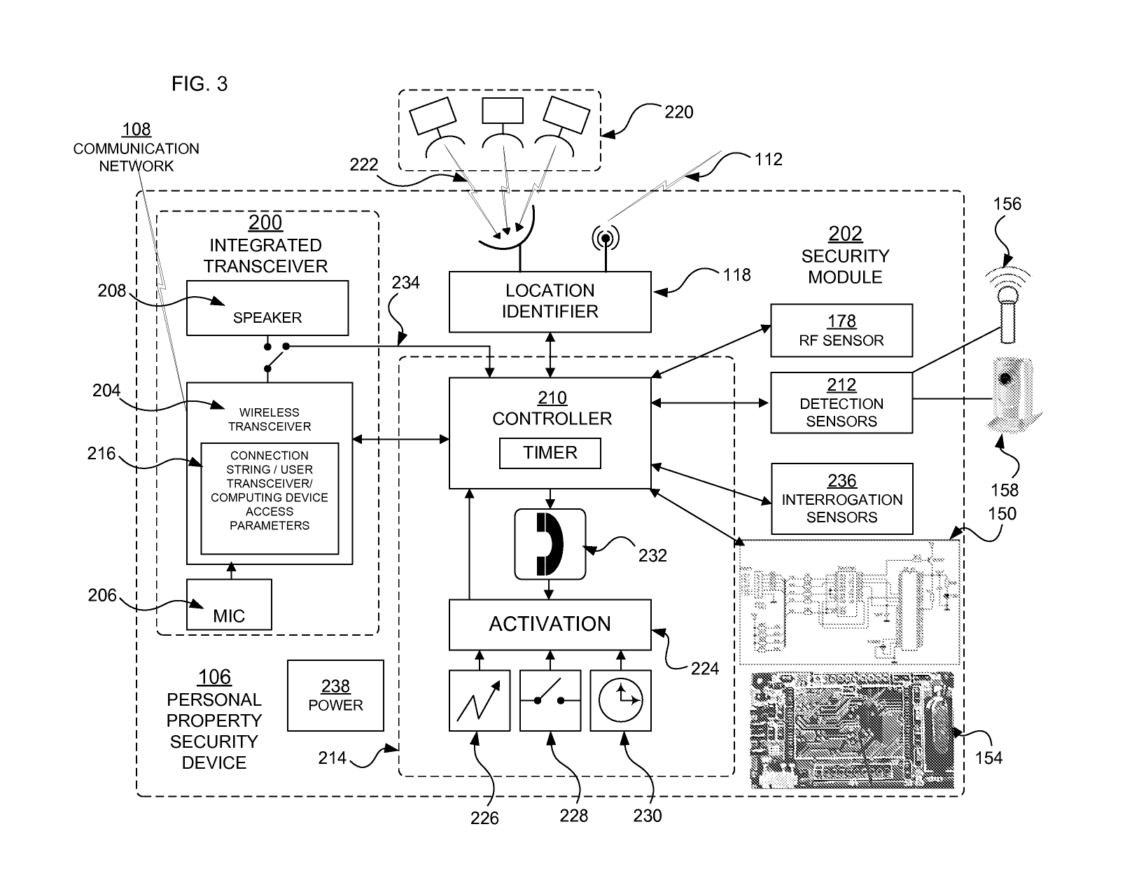

As illustrated in FIG. 1C, the monitoring device 106 may further comprise a memory chip 150 that is in electronic communication with a controller 210 (see FIG. 3) contained in the security device 106. In one embodiment, the memory chip is a typical EEPROM 152 memory storage chip. In some embodiments, the memory chip 152 may form all or part of the memory unit 150. The memory chip 152 may be configured such that it will not lose its content when power to the monitoring device 106 is lost or shut down.

A sensor information storage unit 154 may also be added to the monitoring device 106. The storage unit 154 may comprise any type of device that is capable of storing information. The storage unit 154 is designed to store information gathered by the sensors, including the microphone 156, the camera 158, and/or other input devices so that this information may be available in the future for reference and use. This type of stored information may be particularly helpful in identifying and prosecuting perpetrators. Although the embodiment illustrated in FIG. 1C includes a storage unit 154, embodiments may also be constructed in which the information gathered by these devices is transmitted to and stored by an external storage unit. Examples of the type of systems or devices that may be used as this external storage unit include computers, hard-drives, CD-ROMs, floppy disks, videotapes, audiotapes, or other types of data storage mechanisms.

An interrupt controller, such as an electronic low power device (“ELPD”) 160, or complex programmable logic device (“CPLD”) 162 may also be added to the monitoring device 106. The EPLD 160 is basically a battery saving device that uses extremely little power and remains in contact with the designated sensors. If the sensors detect a problem the EPLD will power up the main controller 210 to initiate a call to the user or a communication to the computing device 116 or an application server 256. The interrupt controller 160 or 162 is a low power circuit that is in electronic communication with one or more of the sensors. Other embodiments may also be made in which the interrupt controller 160 or 162 is also in electronic communication with a low battery sensor 164. Thus, the interrupt controller 160 or 162 allows the entire unit to be essentially shut down to save battery power and yet the sensors can still be active.

The interrupt controller 160 or 162 may be configured so that if the camera 128, the motion detector 130, the proximity sensor 132, the temperature sensor 134, the moisture sensor 136, the infrared sensor 138, the current sensor 140, or one of any other sensors detects a disturbance or change in a condition of the property or the monitoring device 106 or a change in condition in the area around the monitoring device 106, the sensor will signal the interrupt controller 160 or 162. Once signaled, the interrupt controller 160 or 162 will then turn on or activate the controller 210. The interrupt controller may also be configured to obtain additional information from one of the interrogation sensors, such as the camera 128 or the microphone 156, which additional information may assist in determining the legitimacy and exigency of the alarm, such as whether there is a serious alarm condition or whether the condition is just a false alarm.

As depicted in FIG. 1D, the security monitoring device 106 may be a generally rectangular shape 106a, or a disc shape 106b, made small enough to be incorporated into various types of personal property, as noted by comparing the size of the monitoring device 106 shown in FIG. 1D to the size of a U.S. dime 168. The monitoring device preferably includes the basic electronic components 170 of a cell phone. The monitoring device also includes a power port 172 that may be connected to an AC adapter or a DC adapter for recharging the battery of the device, or for attaching to a secondary battery to increase stand-alone battery life or to provide fail-over redundancy. A secondary battery may also be housed in the monitoring device to thwart attempts to overcome the security system by cutting out the power supply.

A USB port 174 may be included for communications with a personal computer. A microphone port 174 and a camera port 176 (for a still camera or a video camera, or both) may also be included. The monitoring device may include a motion detecting port 178 as well as sensor attachment ports 180 and 182 for attaching sensors such as a smoke detector, radiation sensor, external motion sensor, water sensor, weather sensor, or other sensors as may be useful to the user. A port could be used to upload information directly to a hand-held device, or to attach a cut-out or a panic button to the device.

The security device 106 is designed to be small, in some embodiments small enough to integrate into the personal property 104. The result is that the monitoring device 106 is adaptable, reconfigurable, versatile, and can be very modular. It can thus be used for a wide variety of personal property items 104.

The device may be attached using various methods. For instance a magnet may be incorporated so the device may be mounted on any ferro-magnetic surface. Because the device may be small and lightweight, hook and loop fasteners (“Velcro”) or nylon ties may be used to mount the device to different surfaces. Thus, the parts and modules permit adaptation for use in a wide variety of circumstances and environments.

The security device 106 may include an internal RF sensor 178 that is in communication with the controller 210. The RF sensor 178 is designed to transmit signals to, and receive signals from, the antenna 182. The RF sensor 178 can receive a instruction from the controller 210 to contact RFID devices 144. When that instruction is received, the RF sensor sends an interrogation (or other) signal out, and the RFID sensors 144 respond according to programming.

Thus, using the RFID sensors 144 permits the security device 106 to monitor not only specific personal property 104 and the area around that property, but also to monitor specific pieces of property within range of the RFID signal strength. Frequent “pinging” of the RFID sensors permits the security device to provide updates as to status and relative location to the user 102 or application server 256, or both, and each is able to respond with further information requests or programming changes to the security device 106 as well as any of the RFID sensors 144. The bidirectional communications between each element of the entire security system permit great flexibility in the management and design of a security system to meet different circumstances and desires. The RFID devices may be programmed to provide notification if they are detached from the property, or if removed without proper entry of a security code. The user may program the RFID devices, as well as the security device 106, using special codes transmitted over appropriate protocols, thereby controlling access to the RFID devices and the security devices. The RFID devices may even be programmed to provide notification if an additional device comes into proximity to the security device 106, or other monitoring of various RFID-affiliated property.

Upon the triggering or happening of certain events or conditions, the security device 106 autonomously contacts the user 102 by initiating a communication link through the communication network 108 to the user transceiver 110 or the computing device 116. Upon such notification, the user 102 may receive audible or other information about the security device 106 or the surroundings of the security device 106, including information acquired and delivered by the security device 106 to the user transceiver 110 or the computing device 116. The user 102 may respond to such information in various manners. The user 102 may evaluate audible sounds and determine whether such audible information suggests further reactions such as notifying proper authorities. If the personal property 104 has been removed to another location, the user is able to identify the new location by detection of a tracking signal 112 emanating from the security device 106 through the use of a tracking receiver 114 or by evaluation of other packaged location information dispatched from the security device 106 through a separate communication channel or through the communication network 108 to the user transceiver 110 or the computing device 116.

The signals going to and from the RF sensor 178 may be monitored by the controller 210 to provide the monitoring device 106 with information regarding the progress of a telephone call. Specifically, the RF sensor 178 allows the monitoring device 106 to receive information regarding whether an incoming telephone call has been answered, whether an incoming telephone call has ended, whether an outgoing call has been answered by a receiving party, whether an outgoing call has been ended by a receiving party, as well as other valuable information. As a result, the monitoring device reacts appropriately to the instructions transmitted during the telephone call.

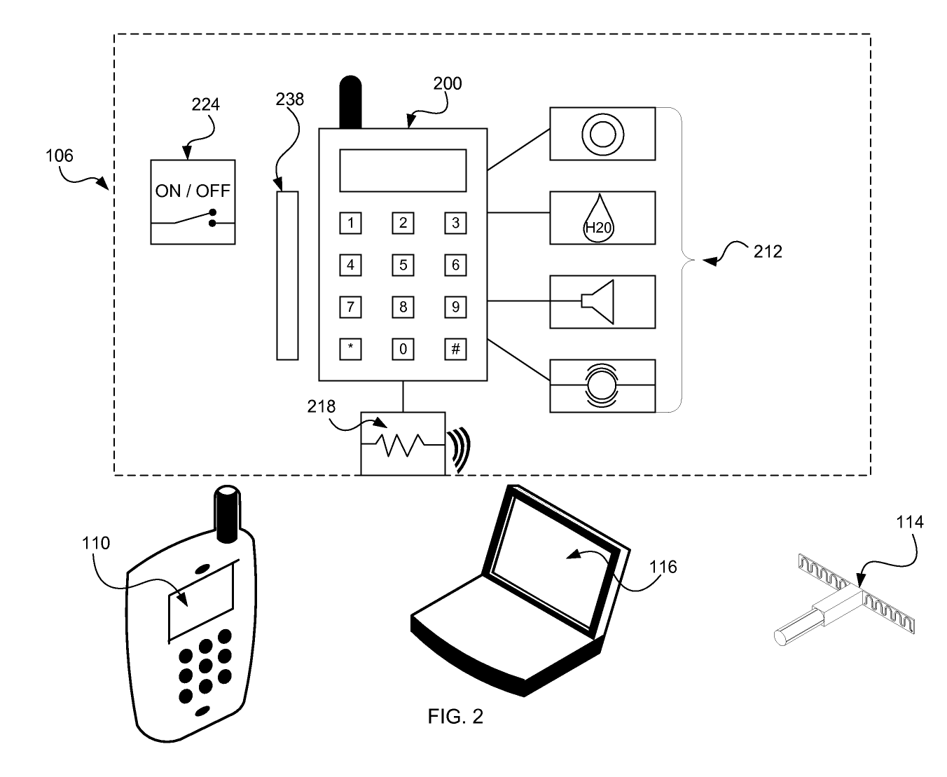

Referring to FIG. 2, in one embodiment, a personal property security device (“PPSD”) including security device 106 and additional devices 120, may also include a combination of several electronic devices. The PPSD may include a digital and/or analog cellular transceiver 200. The transceiver 200 may be used for several purposes. First, the transceiver 200 may be configured to be activated and deactivated by means of a remote transmission from the user transceiver 110 or from the computing device 116. In selected embodiments, a special switch may be installed to activate and deactivate the transceiver 200. Once activated, the transceiver 200 is in a mode ready to discover and communicate with other devices, or to initiate communication with a user transceiver 110, a computing device 116, or a communication network 108 to provide notification of a disturbance to the personal property or the surroundings of the personal property.

In one embodiment of the present invention, when the transceiver 200 receives a disturbance signal from a triggering device or detection sensor 212, the transceiver 200 initiates a connection to a computing device 116 and remains in communication with the computing device 116. The computing device 116 may recognize where the communication originated via a device address, readily known caller identification system, or global positioning data, as may be obtained from the Global Positioning System (“GPS”) provided by the transceiver 200. The security device 106 may communicate with the user transceiver 110, the computing device 116, or one or more hosts participating on the communications network 108, using various control based protocols. Such protocols may require the security device to interact using sophisticated security authentication algorithms, data interchange algorithms, and command and control algorithms.

The use of protocols to identify, authenticate to, and control network traffic is well-known in the typical wired and wireless environments. According to one embodiment of the invention, each RFID sensor 144, each security device 106, each computing device 116, each user transceiver 110, and selected other devices are provided with a unique address. The address may be used uniquely to identify the item to the network. A specific communications protocol may be used for the network. The protocol identifies and authenticates the item to the network, typically by using the unique address. Furthermore, control of the protocol permits control of each item in the network. Thus, the entire network may be centrally controlled, or each item may be centrally or locally addressed and programmed, or both. Use of a specific protocol permits the various devices to communicate even though each type of device, or even each device, may be operating on a different platform.

The user 102 may listen to the audio data transmitted by the transceiver 200 to detect noises corresponding to activity in the vicinity of the security device 106. The user may be able to determine from the sounds in the area of the security device whether the signal was a false alarm or whether the security device 106 has initiated communication because of attempted theft, vandalism, or other trouble.

As shown in FIG. 2, the transceiver 200 or detection sensors 212 may be connected to an on/off or activation switch 224 that can be activated by means of a data communication received from the computing device 116 or the like. The activation switch 224 may be designed to receive a command and control message in accordance with implemented communications protocols from the computing device 116. When the activation switch 224 recognizes the control message, it may cause other parts of the security device 106 or connected devices 120 or 122 to be activated or deactivated as desired. The transceiver 200 may also be connected to other electronic devices such as the devices generally described below.

First, the security device 106 may include a triggering device or detection sensor 212, such as a motion sensor, a shock sensor or the like, and may take several different forms as needed for the specific use of the security device. The detection sensor 212 may take many different forms as the specific need of the security device 106 may dictate and may be activated or deactivated by means of the remotely controlled on/off activation switch 224. In operation, when the security device 106 is activated and in the ready mode, a bump, shock, or jarring, or a movement in the area of the security device may cause the detection sensor 212 to signal the transceiver 200 to initiate communication with the computing device 116 in an attempt to request help. In certain embodiments, the detection sensor may be a simple panic button for a jogger to use if being attacked, or the detection sensor could be a special switch that detects water to signal that a child wearing the security device has fallen into water or the like.

Second, the security device 106 may include a location identifier 218, which in one embodiment assumes the form of a tracking transmitter. One example of tracking transmitters includes devices similar to tracking devices used to tag and to track wildlife or sophisticated receiver-based tracking devices that use GPS. The detection sensors may be configured to activate the location identifier to enable the tracking of movements of the security device. The location identifier is preferably silent in operation.

For an embodiment that includes a tracking transmitter, the tracking transmitter typically emits a silent radio signal that is capable of being tracked by a directional tracking device such as the tracking receiver 114. For example, a simple animal tracking collar has been found to be effective in tracking movements of a security device for distances of several miles to tens of miles or more so long as substantial line of sight between the tracking transmitter and the directional tracking device was maintained. Systems capable of tracking movements of a security device at distances beyond many miles are also currently available. Another tracking embodiment uses a receiver-based location identifier to track movements of the personal property asset. One such embodiment employs the GPS system to track movements. In such an embodiment, the security device 106 relays positioning data to the computing device 116, which may then be used in conjunction with tracking or mapping systems to locate the security device 106.

Third, as depicted in FIG. 2, the security device 106 may include a long life rechargeable battery or power source 238, which typically provides power to the components of the security device 106 that are located with the secured personal property, including the transceiver 200, the on/off or activation switch 224, the triggering or detection sensors 212, and the location identifier 218. The power source 238 is typically as small as possible so that the security device may be inconspicuously attached to personal property and not be too heavy to be worn on a child's belt for such an application. For applications that use a cellular telephone as the transceiver, the power source or battery of the cellular telephone may be used to power the other components of the security device.

As described above and depicted in FIG. 2, the security system may include a directional tracking receiver 114. The tracking receiver 114 is typically a separate device that is kept close at hand by the user of the personal property security device 106, when the security device is in use. For example, a tracking receiver 114 may be attached to a personal property owner's cellular phone, such as the transceiver 200, or to the computing device 116, or may be incorporated into the user's wireless transceiver such that the tracking receiver 114 or computing device 116 and the user transceiver 110 will always be together, when needed.

The tracking receiver 114 may be activated by the user when the security device 106 provides notification of a disturbance to the personal property. The tracking receiver 114 indicates in which direction the personal property has been moved. The tracking receiver 114 may be designed to pick up the signal given off by the location identifier (e.g., tracking transmitter) 218. If the user has several security devices, multiple or a single location identifier (e.g., tracking receiver) may be configured to track any of the security devices 106 in use. Use of appropriate communications protocols permit individual tracking of each of the security devices in use. In embodiments that incorporate GPS technology, a screen on the computing device 116 may display the position of the security device. Typical embodiments of the security devices may be built small and compact enough to be inconspicuous and able to be attached to most anything that a person would want to protect from theft or vandalism, or as the case may be, from other hazards.

Operationally in a digital network embodiment, upon activation, triggering, or detection of a disturbance, the security device 106 automatically sends data to a computing system 252. The computing system 252 may comprise a computer network, such as the Internet 254, and an application server 256. When communicating with the computing system 252, the security device 106 may transmit data identifying the security device 106 and alerting the user 102, or a security monitoring service that monitors alerts on the application server 252, of a disturbance of the personal property item 104. The user can then determine whether to call the police, respond to the signal, or what other action to take. The user may decide to go to the location of the item being disturbed and find the thief still in the process of stealing the personal property item 104.

Once triggered, the security device 106 may also transmit to the user via the computing system 252 any sounds that it picks up in its vicinity via the microphone 156 or the microphone 206, thereby allowing the user 102 or the security monitoring service to listen in on what is taking place and help determine if the disturbance is a false alarm. The security device 106 can be totally silent so that the thief may never know that he has been detected. The user or monitoring service can then determine whether to call the police or if the disturbance was a false alarm. The security device 106 may also have activated its tracking transmitter when it was disturbed thereby allowing the user, if the personal property had already been removed, to track or follow the security device 106 to its new location. This would allow the user to contact the police and have the thief arrested and the personal property 106 to be recovered.

The security device 106 may have extremely wide application, as it is adaptable to be useful to almost everyone for a wide variety of protection uses. It may assume a small and compact embodiment thereby enabling it to be attached in inconspicuous places where a thief will not likely see it. It can be attached to vehicles, mobile trailers, power tools, bicycles, stereos, TVs, boats, motorcycles, etc. It may even be adapted to be activated with a panic button or water sensor and attached to children or joggers or even old persons, and the like. The security device 106 may facilitate alerting people when a wearer is disturbed or a child has fallen into water such that location may be determined quickly and easily via the tracking capabilities already described. A user 102 of the security device 106 or parent of a child using the device can be more assured of knowing when trouble has occurred and can respond to the exact location of the trouble quickly. A user may desire to use many security devices to monitor the safety and location of several items of personal property in various locations.

Each security device may be designed to transfer a unique identifier address to enable a user 102 to determine what personal property or persons are being disturbed or are distressed. The security device 106 may be designed to be small, compact and totally self-contained, making it portable and independent of outside power sources except for the need to be recharged periodically or may draw power from some other source. These features make embodiments of the security device 106 extremely mobile and versatile.

FIG. 3 is a detailed block diagram of a personal property security device 106 in accordance with an embodiment of the invention. For clarity, the security device 106 is partitioned into a transceiver portion for establishing a communication link with a communication network and a security or detection portion for control of sensor devices that either may be triggered or may be interrogated by the user to obtain additional information.

In FIG. 3, the security device 106 is partitioned into a transceiver 200 depicted as an integrated transceiver comprised of a wireless transmitter/receiver 204 and a microphone 206 and speaker 208. Those of skill in the art appreciate that the integrated transceiver 200 may be implemented either as discrete components on a circuit board or in a packaged assembly assuming the form of, for example, a cellular or other similar telephone or radio. The security device 106 is further comprised of a security module 202 for performing evaluation and control of the security device and any accompanying sensors. The security module 202 may interface with the transceiver 200 through various means including combined integration of (i) the various components associated with the integrated transceiver 200 with (ii) the various components associated with the security module 202 on a common circuit board or multiple circuit boards. When an integrated transceiver is employed, a convenient interface between the devices may be provided by a data port or other hands-free interfaces commonly associated with integrated transceivers.

The security module 202 is comprised of a controller 210 and detection or triggering sensors 212. The detection sensors 212 may be autonomous sensors that provide an interrupt or other signal to the controller 210 or may be monitored under the direction of the controller 210 and implemented as a peripheral device whose state is monitored by the controller 210. The controller 210 interfaces with the wireless transceiver 204 via an interface 214, and interfaces with the RF sensor 178 as discussed above. Upon the detection of sensor information, the controller 210 may initiate a direct digital data connection using a communications protocol such as the Internet Protocol (“IP”) or may initiate a dialing sequence using the wireless transceiver 204, which causes the wireless transceiver 204 to initiate a call using a preset number or preprogrammed dialing string 216, which may correspond to the routing or phone number of the user transceiver 110 (FIG. 1A). Once a communication channel is established, the controller 210 may forward sensor information or may allow audible tones detected by the microphone 206 to be passed via the wireless transceiver 204 to the user transceiver 110 or the computing device 116.

The security module 202 may further comprise a location identifier 218, which may be under the control of the controller 210 or may be autonomous and be activated by the controller 210 or, alternatively, may provide information to the controller 210 in the form of location data. The present invention contemplates at least two embodiments of the location identifier 218. In a first embodiment, the location identifier 218 is implemented as a tracking transmitter or beacon that, when activated, broadcasts a tracking signal 112 that may be detected and located through the use of a tracking receiver 114 (FIG. 1A). Such an embodiment is one in which the location identifier 118 assumes a transmitter role.

In an alternate embodiment, the location identifier 218 assumes a receiver role in which the remote location transmitters 220 transmit signals 222 that are received at the location identifier 218 and may be read and provide location data to the controller 210 for forwarding over the communication network 108 (FIG. 1A) for evaluation and interpretation by the user transceiver 110 (FIG. 1A) or the computing device 116. Such location data may be longitudinal/latitudinal data interpretable by the user 102 (FIG. 1A) or other information processable by the user 102 that relates to the location of the security device 106. Those of skill in the art will appreciate that the location transmitters 220 may take the form of fixed site or orbiting types of transmitters, with one such embodiment including the GPS system, known by those of skill in the art.

Additional features contemplated by the present invention include activation circuitry 224 that allows the user 102 or another entity, such as the computing system 252 (FIG. 1A), to activate the alarming or security features of the security device 106. Activation implementations contemplated include a remote transmission activation device depicted as a transmitter activation 226, known by those of skill in the art to include devices such as “remote-keyless entry”-like devices, or similar devices known by those of skill in the art, or activation by means of the computing device 116 or the computing system 252. Other such activation devices include switch activated devices 228 including manual push buttons, toggle switches or other switches activated either manually or by the closing of a door or other similar implementations. Additionally, a timing activation 230 implemented either in the form of a clock or timer is also contemplated as depicted in activation 230. This clock may be contained on the device 202, the security device or on the system 252, or may be a device that receives a timing signal from a cell phone tower or a GPS satellite or other such external source.

Other activation implementations contemplated by the present invention include a dial-in activation 232 wherein a user 102 via the user transceiver 110 or other similar device, or the computing system 252 (either automatically or through human intervention) contacts or dials the integrated transceiver 200, which interacts with the controller 210. In such an embodiment, the controller 210 may monitor audio signals originating from the user 102, which would otherwise be presented to the speaker 208 of the integrated transceiver 200 but are rather routed via an interface 234 to the controller 210 in the form of, for example, DTMF tones or similar key pad tones whose decoding and usage, are known by those of skill in the art. Such an activation keypad sequence may be decoded by the controller 210 for use in activation of the security device 106. The interface may be designed to employ a voice synthesizer as well as a voice recognition system, which may include an internal microphone, capable of recognizing audible words from a user or from a central security system.

While the user 102 may rely upon the information provided via the detection sensors 212, and audible information from the microphone 206, a further embodiment of the present invention contemplates the inclusion of interrogation sensors 236 that may take the form of image-creating peripherals such as cameras or other sensor devices even including temperature sensors for monitoring the safety of the environment about the security device 106, or other data-providing sensors such as security network location data generating devices for use in interrogating mobile or in-transit security devices as well as other sensors, known by those of skill in the art. The security device 106 may optionally include a power module 238 for use in powering the transceiver 200 and the security module 202. Alternatively, the power module 238 may be externally provided to the security device 106. The power module 238 may include a battery or capacitor, or a combination of both. The battery or capacitor may be replaceable. The battery or capacitor may incorporate or be connected to a charger, or may be connected to a backup power source, or may be powered by the item being protected.

The sensors 212 may include various types of sensing devices. Cameras and microphones can provide visual and audio information. However, the sensors may also include such things as a motion sensor, a shock sensor, an audible/sound sensor, a humidity sensor, a fire sensor, a temperature sensor, a detachment sensor, a motion sensor, a smoke sensor, a video sensor, a magnetic sensor, a freezing sensor, an overheating sensor, a weight sensor, a chemical sensor, a radiation sensor, a glass break sensor, an intrusion sensor, a carbon monoxide sensor, a poison sensor, a vibration sensor, or a light sensor. The monitoring device 106 may include a display module (such as a computer screen or LCD screen) to show the status of each of the different aspects being monitored.

The sensors may include a “sleep” mode to conserve power when no stimulus is detected, from which the sensors “awake” upon detecting a stimulus. Furthermore, the monitoring devices 106 and the additional devices 120 and 122 may be used to monitor not only the personal property involved, but also the area proximate the property. To that end, the computing system 252 or the user transceiver 110 may include speakers and visual monitors to display information collected by the monitoring devices and the additional devices, and the monitoring device may be in communication with lighting at the location. Similarly, because the communication in each leg is bidirectional, the monitoring device 106 or the additional devices 120 and 122 may be equipped with speakers to permit the user or security company to transmit audible signals (such as a voice or a warning sound) to the area of the property being monitored.

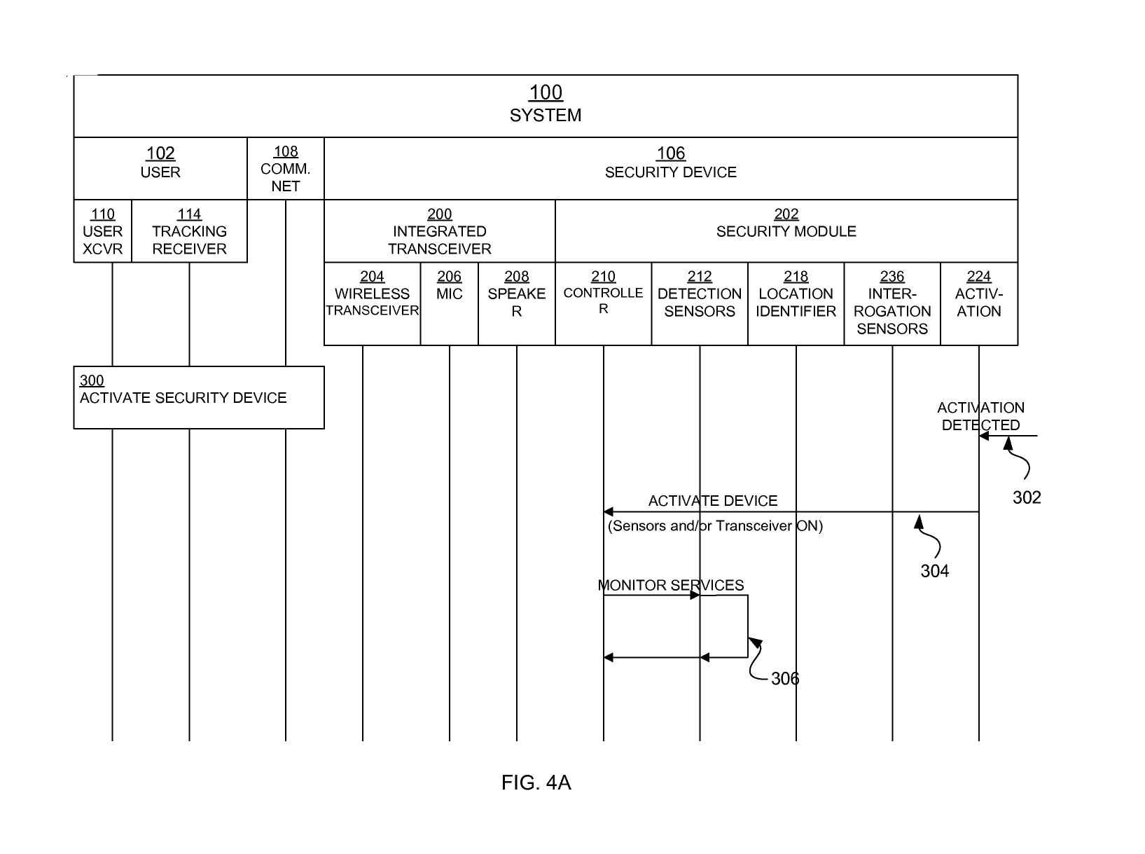

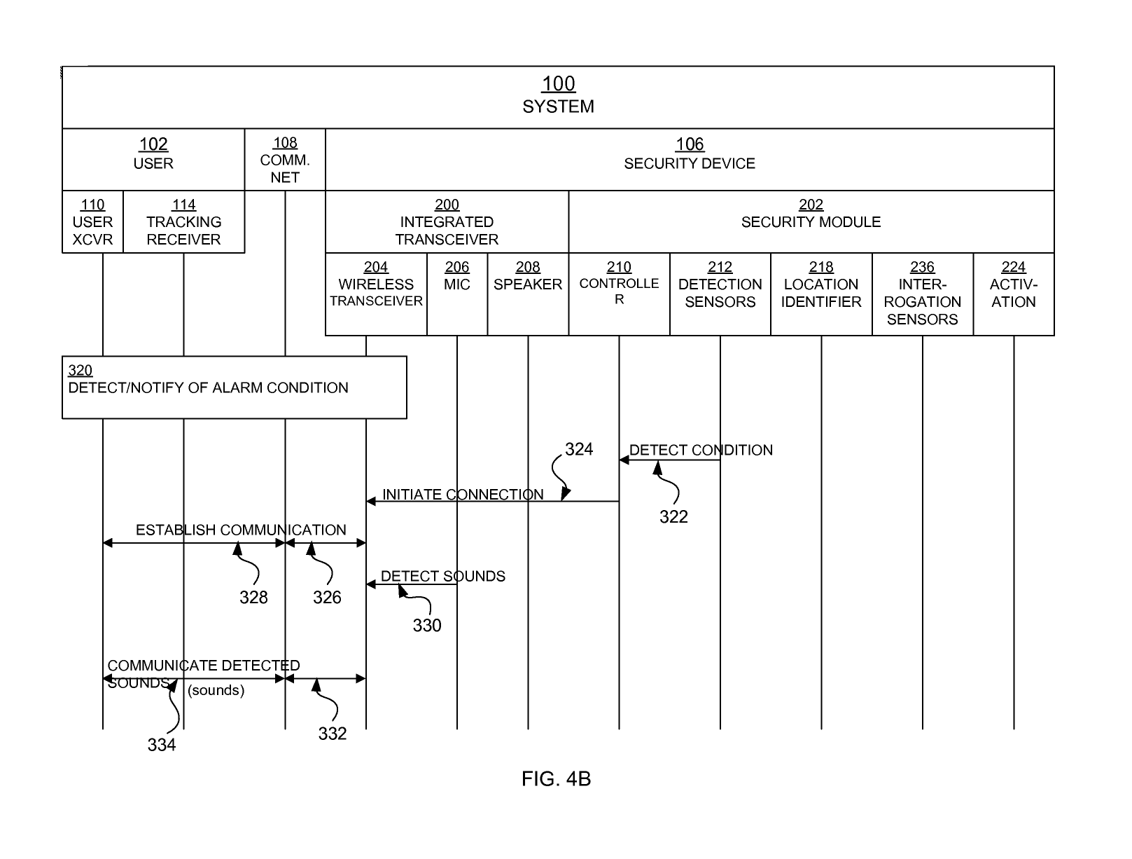

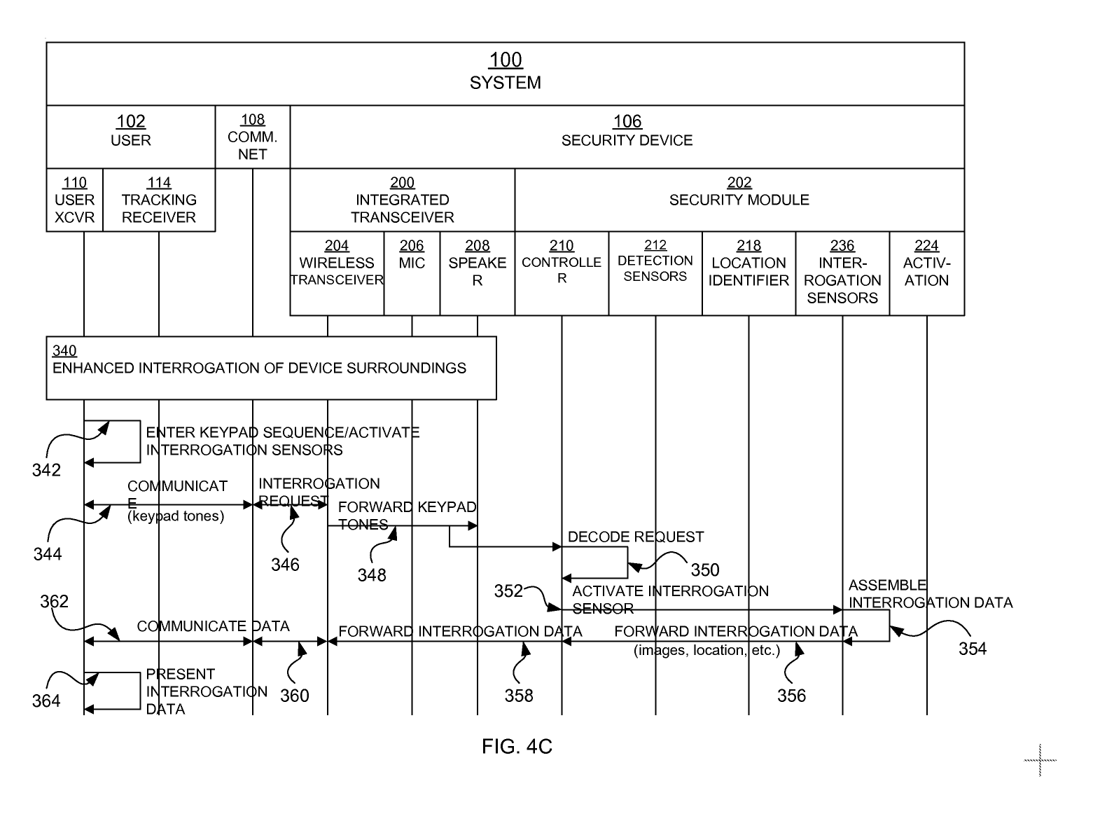

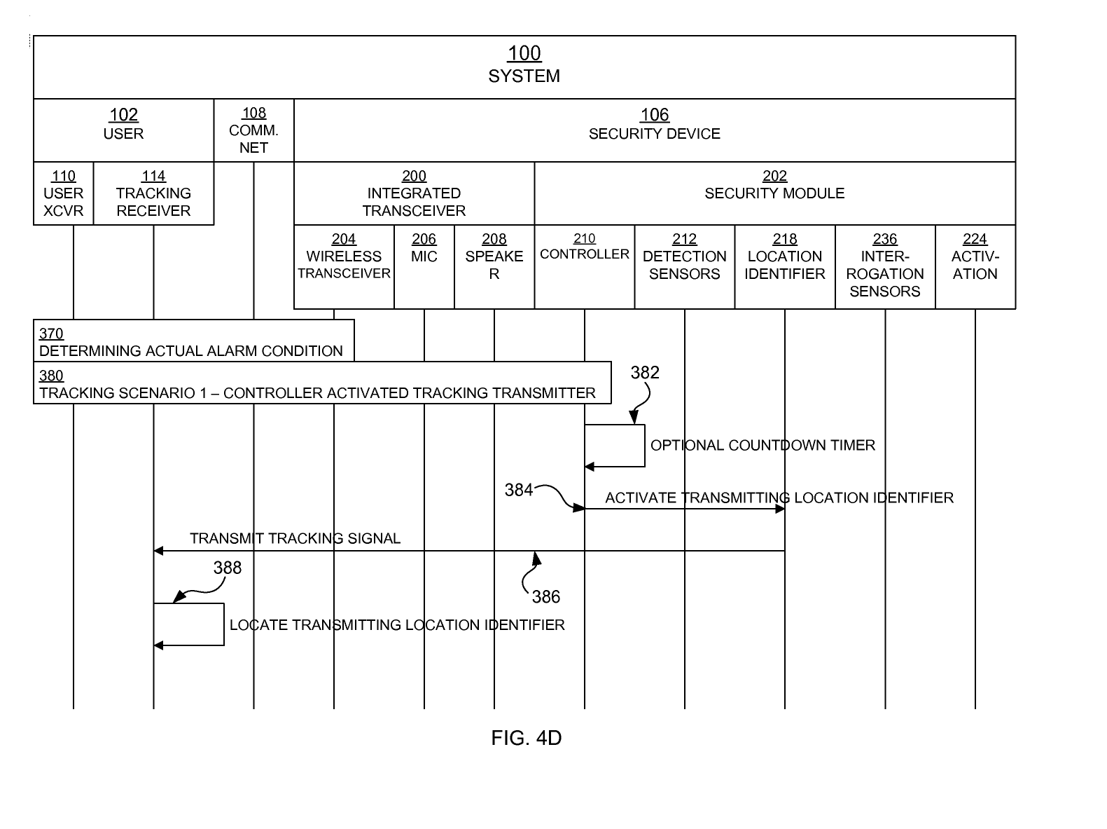

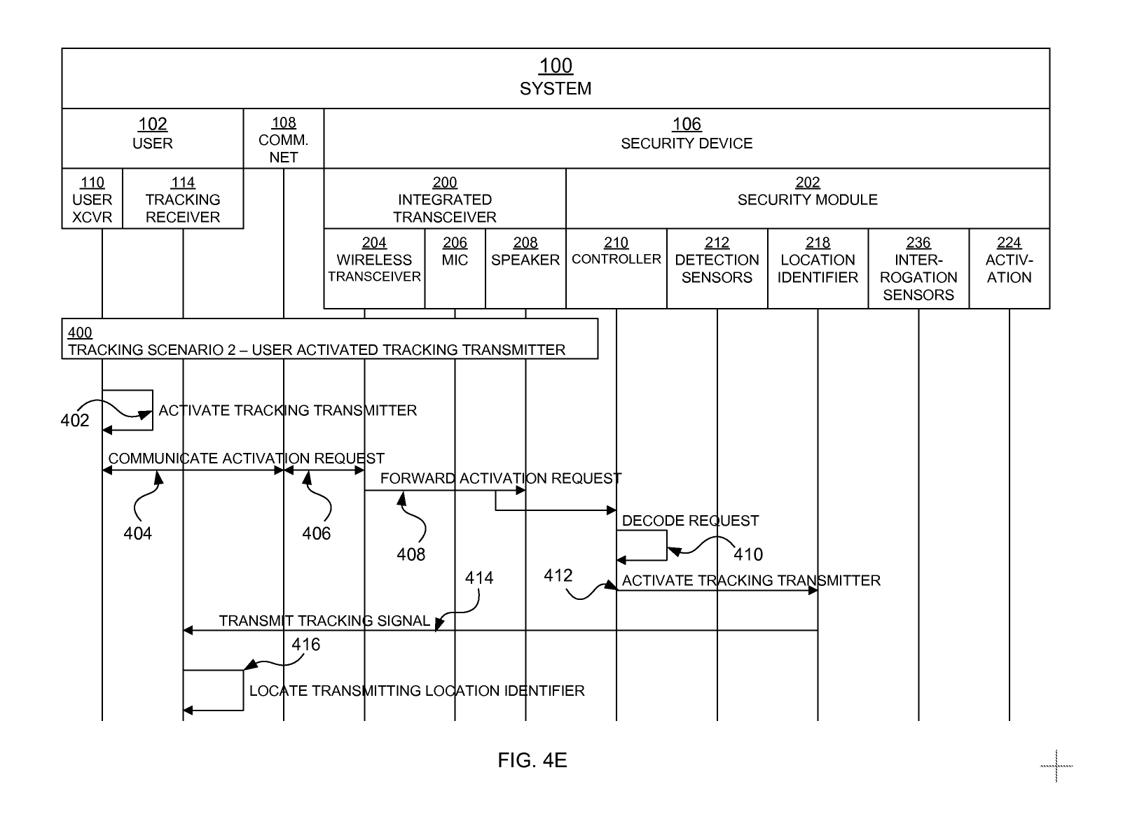

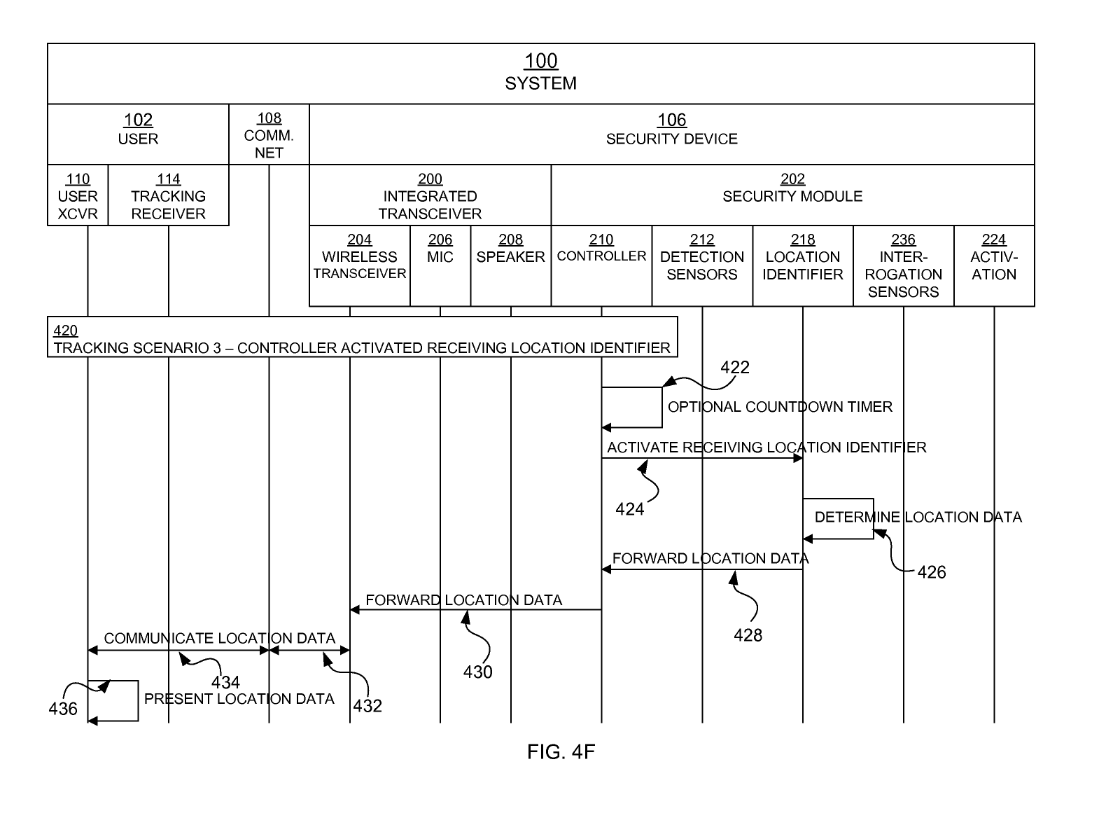

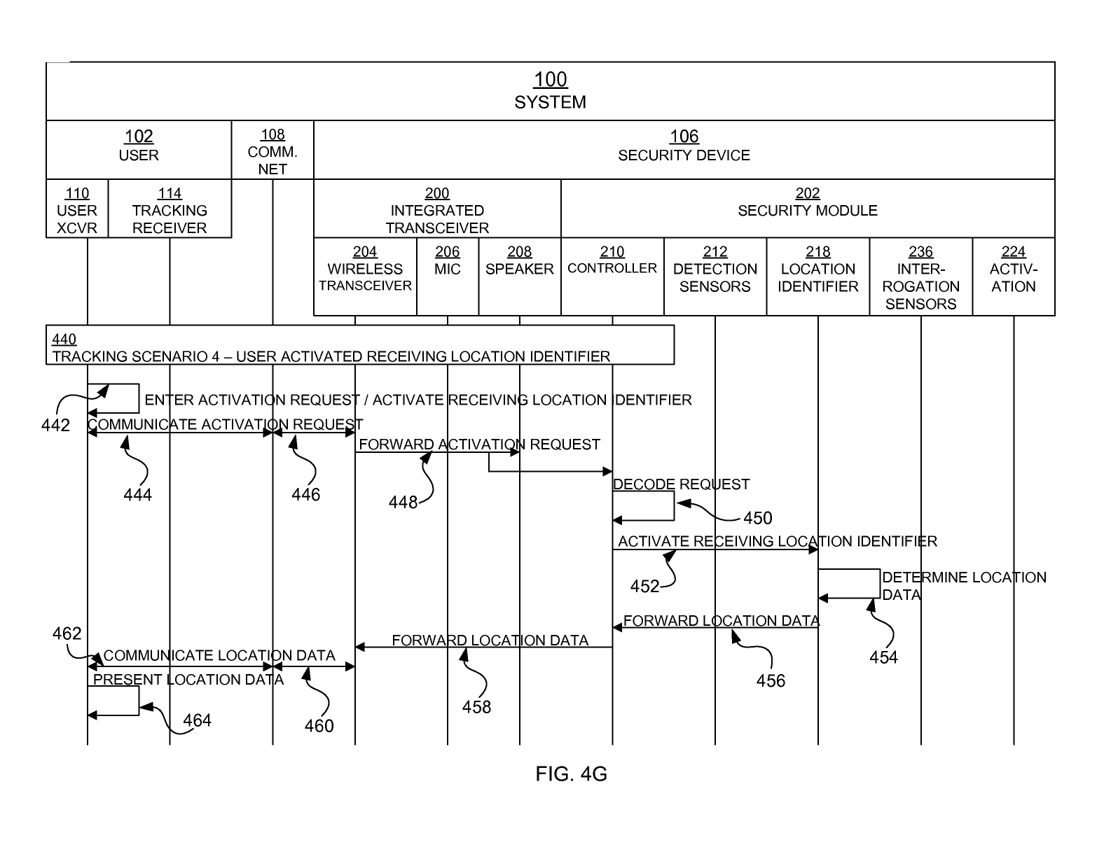

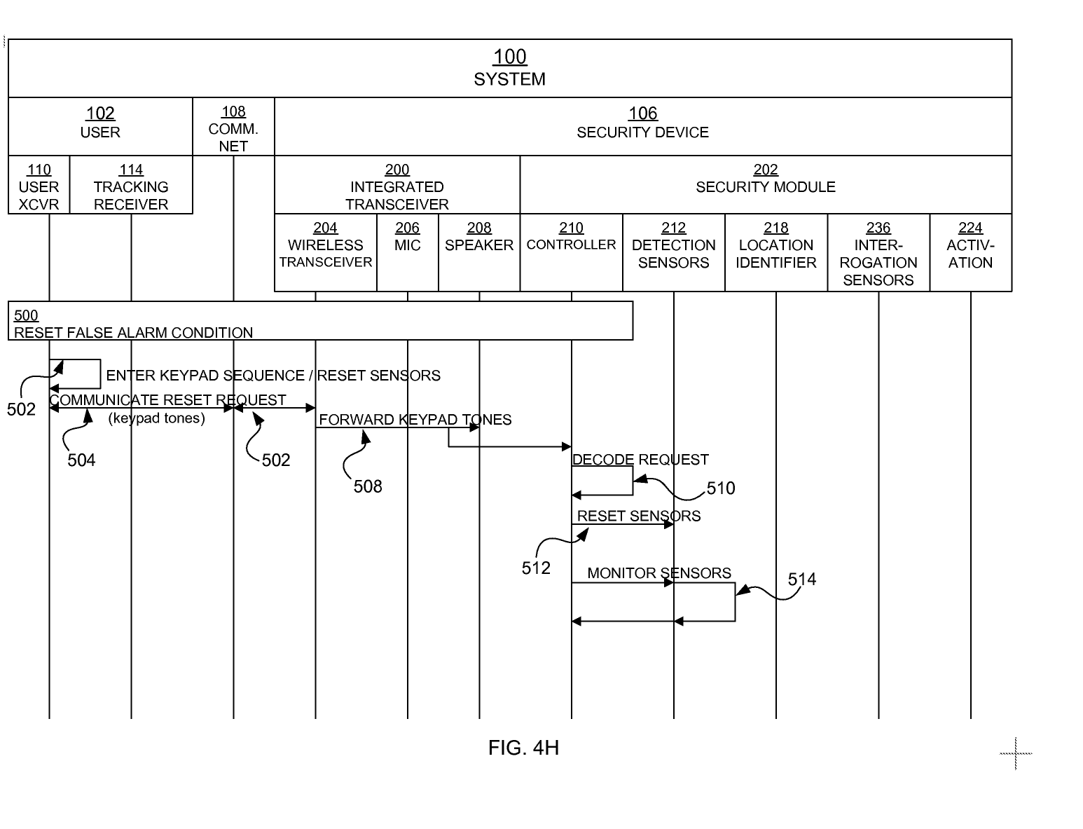

FIGS. 4A through 4H provide flowcharts of the operational steps, in accordance with an embodiment of the present invention. Referring to FIG. 4A, a procedure 300 illustrates activation of the security device 106. As described above, activation may occur according to various means. A step 302 depicts such an activation event received by the activation module 224, which may be included within the controller 210 as software or other procedural devices or may be externally generating an interrupt or other signal to the controller 210, as depicted in activate device step 304. In the step 306, the sensors 212 are activated and continue in a continuous monitoring state and may be implemented as the sensors 212, which assume autonomous monitoring and generate an interrupt to the controller 210 or may be periodically polled by the controller 210.

Referring to FIG. 4B, a procedure 320 illustrates detection and notification of an alarm condition. In the procedure 320, a detect condition 322 is generated either by the sensor 212 or identified by the control 210 in a polling arrangement. The controller 210 initiates a data or voice connection request to the wireless transceiver 204 in a step 324. The wireless transceiver 204 establishes a communication link in steps 326 and 328 via the communication network 108 to a user transceiver 110 or computing device 116. Once such a communication link is established, the microphone 206 may detect and forward sounds or audible tones or other condition information to the wireless transceiver 204 in a step 330. Detected or audible signals are thereafter passed across the communication link in steps 332 and 334 to the user transceiver 110 or computing device 116. The user thereafter may evaluate received information and determine appropriate action.

Alternatively, referring to FIG. 4C, a user 102 in a procedure 340, may elect to undertake enhanced interrogation of the device 106 surroundings in an attempt to better determine whether the sensor detected condition requires emergency intervention. As described above, enhanced or interrogation sensors may be integrated with the security device 106 to provide enhanced conditions such as imagery, infrared detection, or other desirable conditions helpful to a user in evaluating the surroundings about the security device 106. To initiate enhanced interrogation, the present invention contemplates a user 102 in a step 342 initiates a logic sequence, for example, through the use of a keypad sequence that generates a decodable sequence, for example, DTMF tones, or through one or more data packets provided by the computing system 252 communicating by means of the communication network 108. The logic sequence is transferred from the user transceiver 110 or computing device 116 or from the computer system 252 to the wireless transceiver 204 via steps 344 and 346 over the communication link 108 either originally established as initiated by the detection of a sensor or through a user initiated communication link 108.

After initial detection and notification of an alarm condition in procedure 320 or after further enhanced interrogation in procedure 340, a user may determine whether or not a sensed alarm condition is an actual alarm condition as described in procedure 370 (see FIG. 4D) or a false alarm condition as described below in procedure 500 (see FIG. 4H). When a user determines or elects to declare the alarm condition as an actual alarm condition, various tracking scenarios may ensue. Several tracking scenarios are illustrated in FIGS. 4A through 4H and described below.

In procedures 380 (see FIG. 4D), a tracking scenario is illustrated wherein the security device 106 initiates activation of the location identifier 218, which assumes a tracking transmitter configuration. In a controller 210 activation scenario, a step 382 illustrates an optional countdown timer wherein the controller, upon the detection of a triggering event from the detection sensors 212, delays the activation for a period of time allowing the user to evaluate and perhaps further interrogate sensors before activating the tracking signal 112. Upon expiration of the optional countdown timer, the controller 210, in a step 384, activates the transmitting location identifier 218. The location identifier 218, in a step 386, transmits the tracking signal 112, which is detected by a user or other entity utilizing a tracking receiver 114. The tracking receiver 114, in a step 388, locates the transmitting location identifier 218, thus concluding tracking scenario 380.

An alternate tracking scenario is illustrated as procedure 400 (see FIG. 4E) which also employs a location identifier 218 implemented as a tracking transmitter. However, in this scenario, the tracking transmitter is activated by the user upon determination that the alarm is in fact an actual alarm rather than a false alarm. In procedure 400, a user enters a keypad sequence or encodes an activation request using computing device 116, in a step 402, which is communicated to the wireless transceiver 204 in steps 404 and 406. Alternatively, the security service, working through the computer system 252, encodes an activation request, which is communicated to the wireless transceiver 204 in steps 404 and 406.

The wireless transceiver 204, in step 408, forwards the keypad sequence or activation request to the controller 210 whereupon the controller 210, in a step 410, decodes the keypad tone sequence or activation request and determines the requested course of action. Upon decoding, the controller 210, in a step 412, activates the transmitting location identifier 218 which in turn, in a step 414, broadcasts or transmits the tracking signal 112 to the tracking receiver 114. In a step 416, the tracking receiver 114 locates the transmitting location identifier 218, thus concluding procedure 400.

In yet another tracking scenario depicted as procedure 420 (see FIG. 4F), a location identifier 218 is implemented as a receiving location identifier that receives signals and determines a location based upon received signals. As described above, the location identifier 218 may be activated by a controller in a step 422, which employs a countdown or delay timer that postpones activation of portions of the circuitry that traditionally require an appreciable amount of power in their operation. In a step 424, the controller 210 activates the receiving location identifier 218 whereupon in a step 426 the location identifier 218 receives the signals 222 (see FIG. 3) and makes a determination or an assembly of location data for forwarding in step 428 back to the controller 210. The location data is further forwarded in steps 430 to the wireless transceiver 204, and further in steps 432 and 434 over the communication network 108 to the user transceiver 110, computing device 116, or computer system 252. In a step 436, the location data is presented to a user for interpretation, thus concluding tracking scenario 420. Alternatively, in a step 438, the location data is presented to the computer system 252 for interpretation by a security service, thus concluding tracking scenario 420.

In yet another tracking scenario depicted as procedure 440 (see FIG. 4G), a user (or the security service) activates the receiving location identifier 218 through a keypad sequence or activation request sent by means of the computing system 252. In a step 442, a user (or the security service) enters a keypad sequence or activation request of the location identifier 218. In steps 444 and 446, the activation request is communicated over a communication network 108 to the wireless transceiver 204. The wireless transceiver 204 forwards in step 448 the activation request to the controller 210, that, in step 450, decodes the activation request and determines that activation is requested. In step 452, the controller 210 activates the receiving location identifier 218 whereupon the location identifier 218 determines location data in a step 454. In a step 456, the location identifier 218 forwards location data to the controller 210, which further relays the location data in a step 458 to the wireless transceiver 204. Over the communication network 108, the location data is forwarded in steps 460 and 462 to the computing system 252 and, if desired, to the user transceiver 110 or computing device 116. In a step 464, the user or the security service managing the computing system 252 is presented with the location data for evaluation and determination of the location of the security device 106, thus concluding the tracking scenario 440.

As described above, when notified of an alarm condition, a user or the security service may determine that such alarm condition is in fact benign and was generated either as the result of inadvertent sensor activation or as a result of overly sensitive sensors or transient alarm conditions acceptable to the user. Procedure 500 (see FIG. 4H) depicts the steps associated with the evaluation following determination of a false alarm condition. In a step 502, in response to the determination of a false alarm condition, the user (or the security service, working through the computing system 252) enters a keypad sequence or reset request to reset the tripped or triggered sensors. The reset request is relayed over the communication network 108 in steps 504 and 506 to the wireless transceiver 204. In a step 508, the wireless transceiver 204 forwards the keypad tones to the controller 210, whereupon in a step 510 the controller decodes the reset request and determines that the user has requested that the sensors be reset. The controller 210, in a step 512, initiates reset of the sensors 212 whereupon the sensors, alternatively in conjunction with the controller 210, continues monitoring in a step 514.

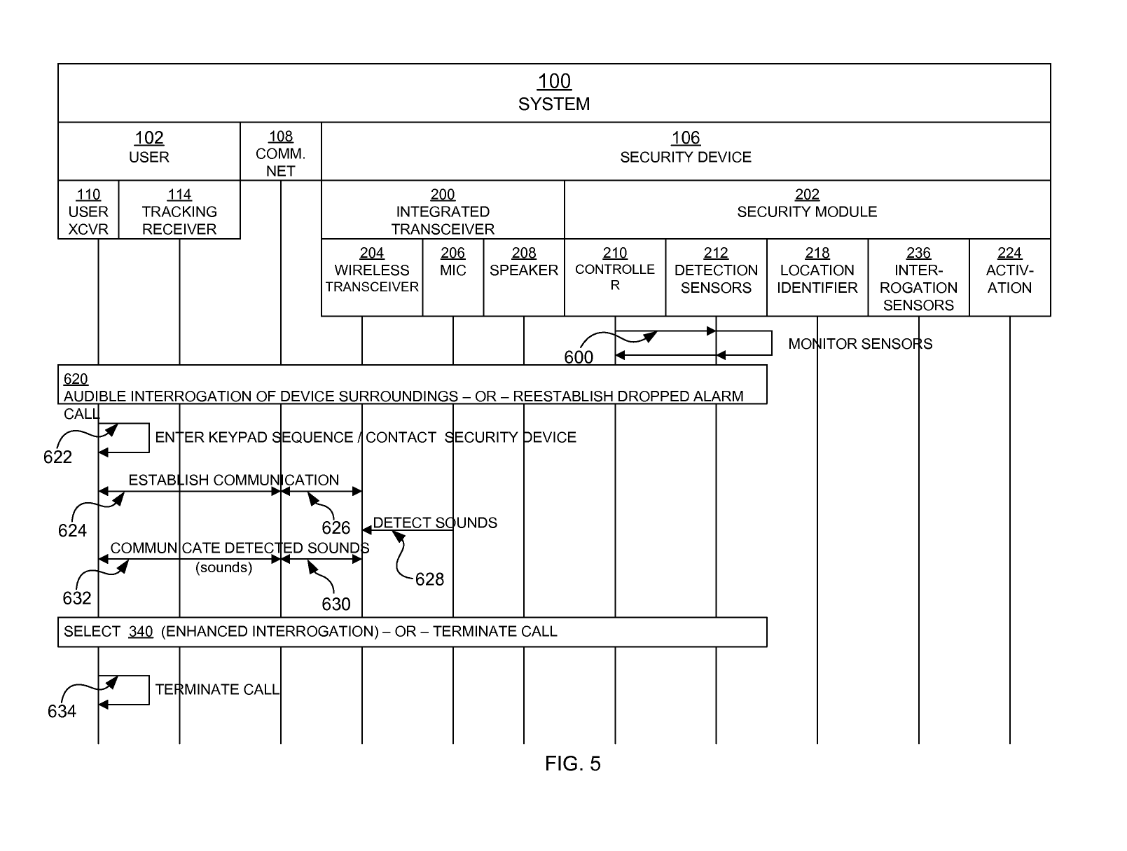

FIG. 5 illustrates a user-initiated interrogation of the device surroundings, in accordance with the present invention. The present invention contemplates a scenario where a user or a security service may initiate a contact with a security device 106 to evaluate the status of the security device 106 including any surrounding conditions perceivable to the security device 106. In such a scenario, the controller and sensors are undergoing monitoring in a step 600 representative of an activated sensor state described above. In a procedure 620, a user initiates the establishment of a communication link over the communication network 108 for one of various reasons, such as (i) the desire by the user to evaluate the security device or its surroundings or (ii) to reestablish a dropped call that may have been initiated by the security device in response to detection sensor activation.

In a step 622, a user or the security service enters a keypad sequence or initiates a communication link to the security device 106. A communication link is established over the communication network 108 in steps 624 and 626. Once a communication link has been established between the user transceiver 110 or computing device 116 and the wireless transceiver 204, a sensor such as the microphone 206 detects sounds, in a step 628, and forwards those sounds/data, in steps 630 and 632, to the user transceiver 110 or computing device 116 for perception and evaluation by the user 102. Should the user desire enhanced interrogation, the user may proceed to query the interrogation sensors 236 according to the procedure 240 described above. When a user or the security service concludes audible interrogation and any optional enhanced interrogation, the user terminates the call in a step 634 and the system resumes its monitoring state. Alternatively, when a communication link is established, the user or security service deactivates the sensors 212 or performs other controlling functions relating to the security device through the use of a keypad sequence or communications link, such as placing security device into a standby or inactive state.

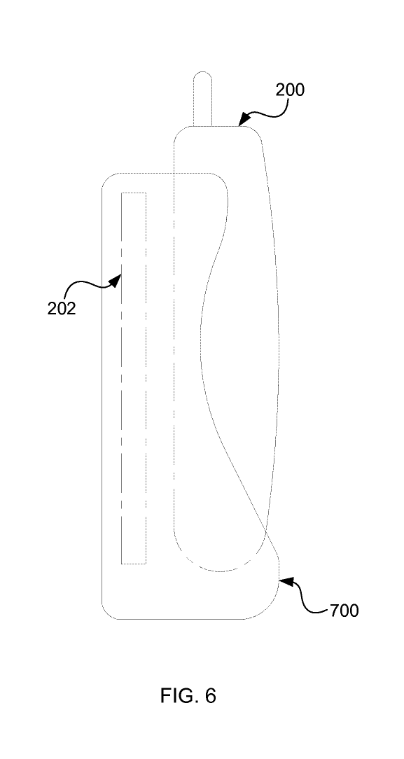

Another scenario may include automation by the security device 106. The security device 106 could be used to activate or deactivate, depending on conditions detected in the vicinity of the security device 106, one or more other devices such as lights, strobe lights, heaters, sounding devices, sirens, alarms systems, relays, switches, detectors or other electromechanical devices. Those of skill in the art will appreciate numerous other scenarios will be likely, particularly as additional RFID devices are included into the mesh network of the security system, because of the interaction between the RF sensors 178 and the controllers 210. FIG. 6 illustrates a mechanical arrangement of an integrated transceiver 200 being received within a housing 700 that includes a security module 202 and the associated mechanical coupling of the integrated transceiver 200. The integrated transceiver 200 assumes a generally integrated handset form-factor providing transceiver functionality as described above in relation to the wireless transceiver 204 and further includes the microphone 206 and speaker 208 with the general interfaces 214 and 234 (see FIG. 3).

Also illustrated in FIG. 6 is a housing 700 that generally attaches or receives the integrated transceiver 200, which in one embodiment receives the integrated transceiver 200 and electrically mates with exposed electrical contacts (e.g., hands-free or modem-coupling interfaces) for coupling with a security module 200 integrated within the housing 700. The housing 700 may mate with the integrated transceiver in either a “holster-like” receiving arrangement or snap or otherwise couple to the back either over, or place of, the battery portion of the integrated handset. Other mounting and interfacing techniques may be used to couple the security module to the integrated transceiver. Such additional coupling alternatives are contemplated within the scope of the present invention. Other couplings may include additional sensors not originally contained in the security device 106, but that are provided as “add-ons” such as smoke, chemical, or radiation sensors, or other sensors such as cameras.

While the present illustration contemplates an integrated transceiver, it is also contemplated that general transceiver functionality may be provided in a “raw” circuit board configuration to be further packaged in another form-factor exhibiting similar functionality. Also contemplated is an embodiment that integrates the transceiver functionality and the security module functionality into a single integrated device. Further contemplated is an embodiment that is integrated within a larger assembly, such as a vehicle or other device, wherein the control functionality such as an on-board computer may be utilized to provide controller functionality and share yet other sensors, transceivers and the like.

Although particular embodiments of the present invention have been described, those of skill in the art will appreciate that various modifications and changes may be made by those skilled in the art without departing from the spirit and scope of the invention. The present invention may be embodied in other specific forms without departing from its structures, methods, or other essential characteristics as broadly described herein and claimed hereinafter. The described embodiments are to be considered in all respects only as illustrative, and not restrictive.

1. A mobile monitoring device that may be physically attached to and detached from an item of portable property comprising:
a communication interface that is in bidirectional electronic communication with a controller and with an integrated, wireless transceiver, the communication interface configured to provide bi-directional communication capabilities between the mobile monitoring device and a user administration unit, bidirectional communication capabilities between the mobile monitoring device and a telecommunications network that may include a computing device, bi-directional communication capabilities between the mobile monitoring device and the user administration unit through the telecommunications network or the computing device, bidirectional communication capabilities between the controller and another remotely located mobile monitoring device, and bi-directional communication capabilities between the controller and at least one remote sensing unit or at least one sensor;
the controller having a central processing unit configured to receive, to execute, and to respond to programming commands received from the telecommunications network, the computing device, the user administration unit, or an input-output terminal associated with the monitoring device;
at least one location detection and identification element in bidirectional communication with the controller through the communication interface and in bidirectional communication with an antenna;
the transceiver including a microphone and a speaker and being in further bidirectional communication with at least one remote sensing unit or at least one other remote monitoring device;
a primary power source and a secondary power source;
a bi-directional activation interface to activate the controller in response to a change in condition of the device or of the area proximate the device; and
multiple sensors in bidirectional electronic communication with the controller through the communications interface, the sensors configured to monitor a change in a condition of an article of portable property or a condition proximate to the portable property;
wherein the bidirectional communication with the communications interface includes predetermined security algorithms and protocols to ensure reliability of authentication and reliability of communication between the transceiver, the controller, the remote sensing unit, the multiple sensors, the user administration unit, the telecommunications network and the computing device and wherein the mobile monitoring device is sized and adapted such that the mobile monitoring device is covertly usable with a variety of different types of portable property in varying conditions and according to differing security needs.

2. A mobile monitoring device comprising:
a communication interface that is in bidirectional electronic communication with a controller and with a transceiver, the communication interface configured to provide bi-directional communication capabilities between the mobile monitoring device and a telecommunications network, and bi-directional communication capabilities between the mobile monitoring device and a user administration unit through the telecommunications network;
the controller having a central processing unit configured to receive, to execute, and to respond to programming commands;
at least one location detection and identification element in bidirectional communication with the controller through the communication interface and in bidirectional communication with an antenna;
the transceiver including a microphone and a speaker and being in further bi-directional communication with at least one remote sensing unit or at least one other remote monitoring device;
a first power source;
a bi-directional activation interface to activate the controller; and
multiple sensors in bidirectional electronic communication with the controller through the communications interface;
wherein the bidirectional communication with the communications interface includes predetermined security algorithms and protocols to ensure reliability of authentication and reliability of communication between the transceiver, the controller, the remote sensing unit, the multiple sensors, the user administration unit, the telecommunications network and the computing device.

3. The device of claim 2 wherein the communication interface is configured to provide bi-directional communication capabilities between the controller and at least one remote sensing unit or at least one sensor.

4. The device of claim 2 wherein the mobile monitoring device is sized, configured and adapted such that the mobile monitoring device is covertly usable with a variety of different types of portable property.

5. The device of claim 2 wherein the transceiver is integrated with the controller and capable of bidirectional wireless communication.

6. The device of claim 2 further comprising a second power source.

7. The device of claim 2 wherein the telecommunications network includes a computing device.

8. The device of claim 2 wherein the communication interface is further configured to provide bi-directional communication capabilities between the mobile monitoring device and the user administration unit.

9. The device of claim 2 wherein the communication interface is further configured to provide bidirectional communication capabilities between the controller and another remotely located mobile monitoring device.

10. The device of claim 2 wherein the controller is configured to receive, to execute, and to respond to programming commands received from the telecommunications network.

11. The device of claim 7 wherein the controller is configured to receive, to execute, and to respond to programming commands received from the computing device.

12. The device of claim 2 wherein the controller is configured to receive, to execute, and to respond to programming commands received from the user administration unit.

13. The device of claim 2 wherein the controller is configured to receive, to execute, and to respond to programming commands received from an input-output terminal associated with the monitoring device.

14. The device of claim 2 wherein the bi-directional activation interface activates the controller in response to a change in condition of the device or of the area proximate the device.

15. The device of claim 2 wherein the sensors are configured to monitor a change in a condition of an article of portable property or a condition proximate to the portable property.

16. A mobile monitoring device comprising:
a communication interface that is in bidirectional electronic communication with a controller and with a transceiver, the communication interface configured to provide bi-directional communication capabilities between the mobile monitoring device and a remote device;
the controller having a central processing unit configured to receive, to execute, and to respond to programming commands;
at least one location detection and identification element in bidirectional communication with the controller through the communication interface and in bidirectional communication with an antenna;
the transceiver being in further bi-directional communication with at least one remote sensing unit or at least one other remote monitoring device;
a first power source;
a bi-directional activation interface to activate the controller; and
multiple sensors in bidirectional electronic communication with the controller through the communications interface;
wherein the bidirectional communication with the communications interface includes predetermined security algorithms and protocols.

17. The device of claim 16 wherein the remote device comprises a telecommunications network.

18. The device of claim 16 wherein the remote device comprises a user administration unit.

19. The device of claim 17 wherein the remote device comprises a user administration unit that communicates bidirectionally with the mobile monitoring device through the telecommunications network.

20. The device of claim 16 wherein the remote device comprises another remotely located mobile monitoring device.

21. The device of claim 16 wherein the remote device comprises a sensing unit.

22. The device of claim 16 wherein the transceiver includes a microphone and a speaker.

23. The device of claim 16 wherein the communication interface is configured to provide bi-directional communication capabilities between the controller and at least one remote sensing unit or at least one sensor.

24. The device of claim 16 wherein the mobile monitoring device is sized, configured and adapted such that the mobile monitoring device is covertly usable with a variety of different types of portable property.

25. The device of claim 16 wherein the transceiver is integrated with the controller and capable of bidirectional wireless communication.

26. The device of claim 16 further comprising a second power source.

27. The device of claim 17 wherein the telecommunications network includes a computing device.

28. The device of claim 17 wherein the controller is configured to receive, to execute, and to respond to programming commands received from the telecommunications network.

29. The device of claim 27 wherein the controller is configured to receive, to execute, and to respond to programming commands received from the computing device.

30. The device of claim 18 wherein the controller is configured to receive, to execute, and to respond to programming commands received from the user administration unit.

31. The device of claim 16 wherein the controller is configured to receive, to execute, and to respond to programming commands received from an input-output terminal associated with the monitoring device.

32. The device of claim 16 further comprising a bi-directional activation interface that activates the controller in response to a change in condition of the device or of the area proximate the device.

33. The device of claim 21 wherein the sensing unit is configured to monitor a change in a condition of an article of portable property or a condition proximate to the portable property.
